(19) United States
(12) Patent Application Publication
(10) Pub. No.: US 2014/0297681 A1
(43) Pub. Date: Oct. 2, 2014

(54) SEARCH SITE USER CONNECTION SYSTEM USING SEARCH WORDS AND METHOD THEREFOR

(71) Applicant: Dongsik CHOI, Daegu (KR)

(72) Inventor: Dongsik CHOI, Daegu (KR)

(21) Appl. No.: 14/221,428

(22) Filed: Mar. 21, 2014

(30) Foreign Application Priority Data
Mar. 28, 2013 (KR) 10-2013-0033624

(51) Int. Cl. G06F 17/30

(52) U.S. Cl. CPC G06F 17/30522
USPC 707/769

(57) ABSTRACT

A search site user connection system and method using search words are provided. The search site user connection method according to the present invention includes storing at least one first search word input to a search window of a search site by a first user, order in which the first search words have been input, and information of the first user together as one piece of search information; inputting, by a second user, at least one second search word to the search window of the search site; comparing the first search words with the second search words to determine whether the first search words and the second search words match; displaying information for the first user when one or more of the first search words and the second search words match; and connecting the first user selected by the second user with the second user.

### CROSS-REFERENCE TO RELATED APPLICATION

This application claims priority to Korean Patent Application No. 10-2013-0033624, filed Mar. 28, 2013, the contents of which are incorporated into the present application by reference.

### BACKGROUND

1. Field of the Invention

The present invention relates to a search site, and more specifically, to a system and method capable of connecting search site users using search words.

2. Discussion of Related Art

Currently, there are various kinds of search sites in the Internet, and search site users can more easily obtain and use information using the search sites. Further, most search sites are evolved into portal sites not only providing search service, but also providing various services including E-mail, shopping, or auction.

Generally, a conventional search site user can obtain information for interests by inputting search words to a search window of a search site for his or her interests.

Further, the search site user may input search words of interest to the search window in order to find other users having common interests, subscribe to a searched cafe, club or the like, and share information with the other users.

Thus, a conventional search site is inconvenient in that a user should directly find the other users having common interests.

Further, the conventional search site can only show order of search words, and does not provide service of connecting a user with other users having common interests using search words searched for by the user.

### SUMMARY OF THE INVENTION

An object of the present invention is to provide a connection system and method capable of comparing search words searched for by users of a search site with each other, determining whether the search words match, and connecting the search site users having common interests to one another.

In order to solve the above technical problems, a search site user connection system using search words which is an embodiment of the present invention includes a database which stores at least one first search word input to a search window of a search site by a first user, order in which the first search words have been input, and information of the first user together as one piece of search information; a terminal which enables a second user to input at least one second search word to the search window of the search site; and a management server which compares the first search words with the second search words to determine whether the first search words and the second search words match, wherein the terminal displays information for the first user when one or more of the first search words and the second search words match, and the management server connects the first user selected by the second user with the second user.

Specifically, the first user and the second user are users who individually use the search site. In other words, the first user and the second user mean different users. Further, the first user and the second user may be a plurality of users.

The first search words are a set of search words searched for by being input to the search window of the search site by the first user. For example, when the first user inputs “establishment of business” to the search window to perform search and the first user inputs “job” to the search window to perform search, the first search words are “establishment of business” and “job.” Further, only one search word may be input.

Further, the second search words are a set of search words searched for by being input to the search window of the search site by the second user. For example, when the second user inputs “establishment of business” to the search window to perform search and the second user inputs “job” to the search window to perform search, the second search words are “establishment of business” and “job.” In other words, the second search words may be applied like the first search word.

Further, the first user or the second user can perform search using at least one search window. For example, a search window including five search windows may be used, but the present invention is not limited thereto.

In one embodiment, the information for the first user may be at least one of a residential area, an age and a sex of the first user. Specifically, the residential area may be identified in units of cities based on the address of the first user or may be identified based on gu, gun, dong or the like which is an administrative district unit smaller than the city.

Further, the information for the second user may be at least one of a residential area, an age and a sex of the second user. Specifically, the residential area may be identified in units of cities based on the address of the first user or may be identified based on gu, gun, dong or the like which is an administrative district unit smaller than the city.

In one embodiment, the management server may compare the first search words with the second search words to determine whether the first search words and the second search words match, and determine the number of matched search words between the first search words and the second search words.

For example, when the first searched words are searched in order of “establishment of business,” “job” and “Taegu” and the second searched words are searched in order of “establishment of business,” “small and medium enterprise,” and “job,” the management server may determine that the number of the matched searched words is 2 since the “establishment of business” and the “job” of the first searched words and the “establishment of business” and the “job” of the second searched words match.

In other words, the management server may determine the number of matched searched words by comparing all of at least one search word of the first searched word with all of the at least one search word of the second searched word to find the matched searched words.

In one embodiment, the management server may compare the first search words with the second search words based on order in which the first search words and the second search words are input to the search window after determining the number of the matched search words between the first search word and the second search words.

In one example, there are a plurality of first users, and the terminal may display the users sequentially from the users corresponding to the greater number of matched search words between the first search words and the second search words, and may compare the first search words with the second search words based on order in which the first search words and the second search words have been input, and first display the user corresponding to the first input search word when the numbers of matched search words between the first search words and the second search words are the same.

Specifically, since there may be a plurality of first users, the first search words can be a set of a plurality of search words. For example, it is assumed that the first searched words (simply referred to as “search 1”) have been searched in order of “establishment of business,” “job” and “Taegu,” the other first searched words (simply referred to as “search 2”) have been searched in order of “job,” “establishment of business,” and “Taegu,” and the second searched words have been searched as “establishment of business,” “job” and “occupation.”

In this case, since the second search words and search 1, and the second search words and search 2 match in “establishment of business” and “job,” the number of the matched searched words is 2.

Since the numbers of matched search words are the same and are 2, the matched searched words are determined based on the order in which the second search words are input and the order in which search 1 and search 2 are input. For the search word matching “establishment of business” first input among the second search words, “establishment of business” in search 1 has first been input and “establishment of business” in search 2 has secondly been input.

Therefore, search 1 including the first input “establishment of business” may have a higher priority than search 2, and the user who has input search 1 to the search window may first be displayed.

In one embodiment, the management server may determine whether the first search words match the second search words in a state in which at least one of a residential area, an age and a sex of the first user has satisfied a previously setting range.

Specifically, when a user sets the range of the residential area, a determination as to whether the first search words of the first user and the search words of the second user within the set range of the residential area match may be made by comparing the first search words with the second search words. For example, when the range of the residential area is set to “Taegu,” the determination as to whether the first search words and the search words match can be made only when the residential area of the first user is “Taegu.” Further, even when the range of the age or the sex is set, the determination can be made in the same way.

In one embodiment, the information of the first user may further indicate whether the first user is in an online state or in an offline state.

A search site user connection method using search words which is an embodiment of the present invention may include storing at least one first search word input to a search window of a search site by a first user, order in which the first search words have been input, and information of the first user together as one piece of search information; inputting, by a second user, at least one second search word to the search window of the search site; comparing the first search words with the second search words to determine whether the first search words and the second search words match; displaying information for the first user when one or more of the first search words and the second search words match; and connecting the first user selected by the second user with the second user.

In one embodiment, the information for the first user may be at least one of a residential area, an age and a sex of the first user.

In one embodiment, the comparing of the first search words with the second search words to determine whether the first search words and the second search words match may include comparing the first search words with the second search words to determine whether the first search words and the second search words match and determining the number of matched search words between the first search words and the second search words.

In one embodiment, the first search words and the second search words may be compared with each other based on order in which the first search words and the second search words have been input after determining the number of matched search words between the first search words and the second search words.

In one embodiment, there may a plurality of first users, and the users may be displayed sequentially from the users corresponding to the greater number of matched search words between the first search words and the second search words, and when the numbers of matched search words between the first search words and the second search words are the same, the first search words and the second search words may be compared with each other based on order in which the first search words and the second search words have been input, and the user corresponding to the first input search word may be first displayed.

Specifically, since there may be a plurality of first users, the first search words can be a set of a plurality of search words. For example, it is assumed that the first searched words (simply referred to as “search 1”) have been searched in order of “establishment of business,” “job” and “Taegu,” the other first searched words (simply referred to as “search 2”) have been searched in order of “job,” “establishment of business,” and “Taegu,” and the second searched words have been searched as “establishment of business,” “job” and “occupation.”

In this case, since the second search words and search 1, and the second search words and search 2 match in “establishment of business” and “job,” the number of the matched searched words is 2.

Since the numbers of matched search words are the same and are 2, the matched searched words are determined based on the order in which the second search words are input and the order in which search 1 and search 2 are input. For the search word matching “establishment of business” first input among the second search words, “establishment of business” in search 1 has first been input and “establishment of business” in search 2 has secondly been input.

Therefore, search 1 including the first input “establishment of business” may have a higher priority than search 2, the user who has input search 1 to the search window may first be displayed, and information for the user may be displayed together.

In one embodiment, the management server may determine whether the first search words match the second search words in a state in which at least one of a residential area, an age and a sex of the first user has satisfied a previously setting range.

Specifically, when a user sets the range of the residential area, a determination as to whether the first search words of the first user and the search words of the second user within the set range of the residential area match may be made by comparing the first search words with the second search words. For example, when the range of the residential area is set to “Taegu,” the determination as to whether the first search words and the search words match can be made only when the residential area of the first user is “Taegu.” Further, even when the range of the age or the sex is set, the determination can be made in the same way.

In one embodiment, the information of the first user may further indicate whether the first user is in an online state or in an offline state.

In one embodiment, the comparing of the first search words with the second search words to determine whether the first search words and the second search words match may include determining whether the first search words and the second search words match in a state in which at least one of a residential area, an age and a sex of the first user has satisfied a previously setting range.

In one embodiment, the connecting of the first user selected by the second user with the second user may include connecting the first user with the second user through a network.

Specifically, the network may be a wireless network, an Internet network, or a cable network, and is not limited thereto and any other network may be used as long as the network supports communication.

A search site user connection method using search words which is an embodiment of the present invention may include displaying the second search words, date when the second search words are input, a profile of the second user, and a name of the first user connected to the second user.

According to the present invention as described above, it is possible to connect a user and other users having common interests.

Further, since the other users having common interests to the user can be displayed using search words, it is not necessary for the user to directly search for the other users having common interests.

Further, the users having common interests can share information with one another or talk to one another.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating an embodiment of a search site user connection system using search words according to the present invention;

FIG. 2 is a flowchart illustrating a search site user connection method using search words according to the present invention;

FIG. 3 is a diagram illustrating an embodiment in which search words are input to a search window of a search site according to the present invention;

FIG. 4a is a diagram illustrating an embodiment in which information for a first user is displayed based on a result of determining matched searched word between first search words and second search words according to the present invention;

FIG. 4b is a diagram illustrating another embodiment in which the information for the first user is displayed based on the result of determining matched searched word between first search words and second search words according to the present invention;

FIG. 4c is a diagram illustrating yet another embodiment in which the information for the first user is displayed based on the result of determining matched searched word between first search words and second search words according to the present invention; and

FIG. 5 is a diagram illustrating an embodiment in which second search words, date when the second search words are input, a profile of a second user, and a name of a first user connected to the second user are displayed.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, a preferred embodiment according to the present invention will be described in detail with reference to the accompanying drawings. The same reference numerals denote the same elements in the drawings.

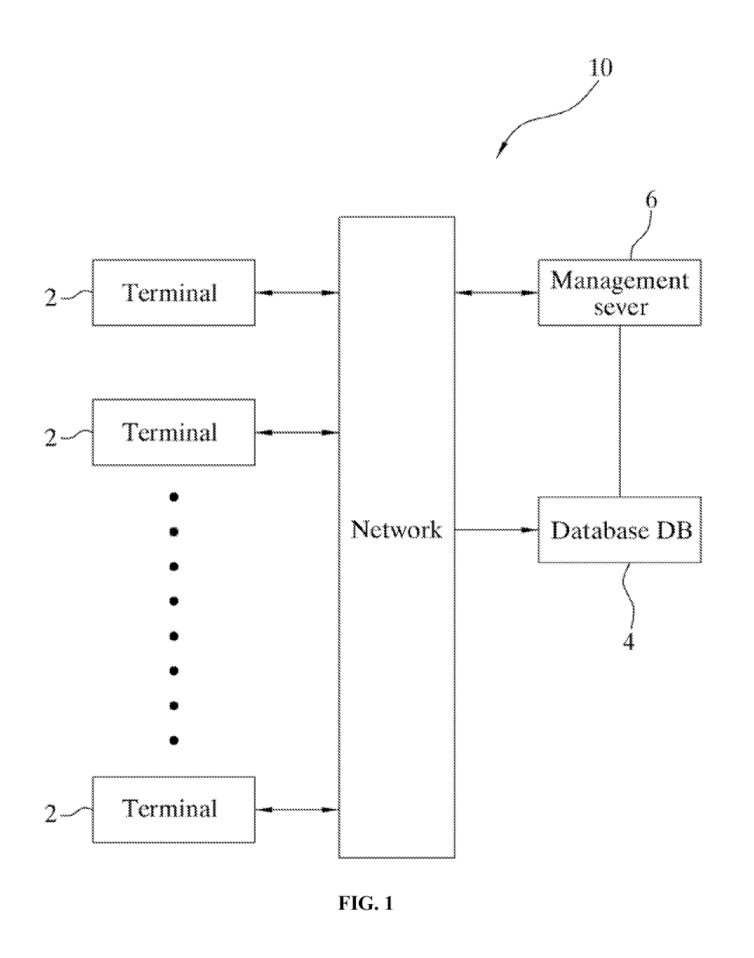

FIG. 1 illustrates one diagram illustrating an embodiment illustrating a search site user connection system using search words according to the present invention.

Referring to FIG. 1, a search site user connection system 10 using search words according to the present invention may include a terminal 2, a database 4 and a management server 6.

The terminal 2 may include an input unit (not illustrated) which allows search words to be input, and a display unit (not illustrated) which can display a result of a determination of the management server 6 and information for a first user, which will be described below in detail.

The first user or a second user can input search words to a search window of the search site through the terminal 2. Further, the terminal 2 may include a plurality of terminals, and each of the first user and the second user may include a plurality of users.

The search words may be input to the search window through the input unit of the terminal 2. For example, the terminal 2 may be a computer, a PDA, a mobile phone, or a smartphone. For example, the input unit may be a keyboard, a keypad or a touch screen.

Further, a microphone applied to the terminal 2 may be used as the input unit. When the microphone is used as the input unit, the first user or the second user may input search words to the search window by voice via the microphone. The search words spoken by the first user or the second user may be recognized through a voice recognition program, and the recognized search words may be input to the search window. For example, the first user speaks the word “establishment of business” to the microphone, the search word “establishment of business” may be input to the search window. The voice recognition program may be stored in the database 4 or the management server 6, known voice recognition technology may be used for the voice recognition program, and a detailed description of the voice recognition technology is omitted.

Since a program capable of activating a web page is installed in the terminal 2, the first user or the second user can access the search site and input search words.

Further, the terminal 2 may display the information of the first user based on a result of comparing the first search words with the second search words and making a determination in the management server 6. In other words, when one or more of the first search words and the second search words match, the information for the first user may be displayed. The second user can confirm the information for the first user obtained based on the determination result of the management server 6 through the terminal 2.

The database 4 may store at least one first search word input to the search window of the search site by the first user, order in which the first search words have been input, and the information for the first user together as one piece of search information. Further, the same may apply to the second user.

The management server 6 may compare the first search words with the second search words and determine whether the first search words and the second search words match. This will be described below in detail. Further, the management server 6 may connect the first user selected by the second user with the second user.

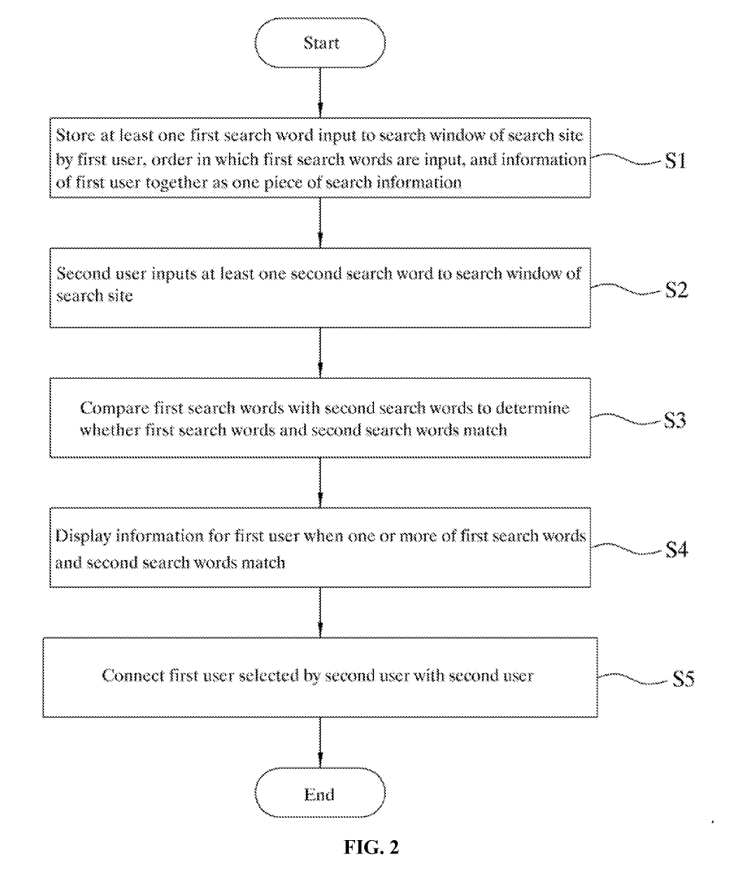

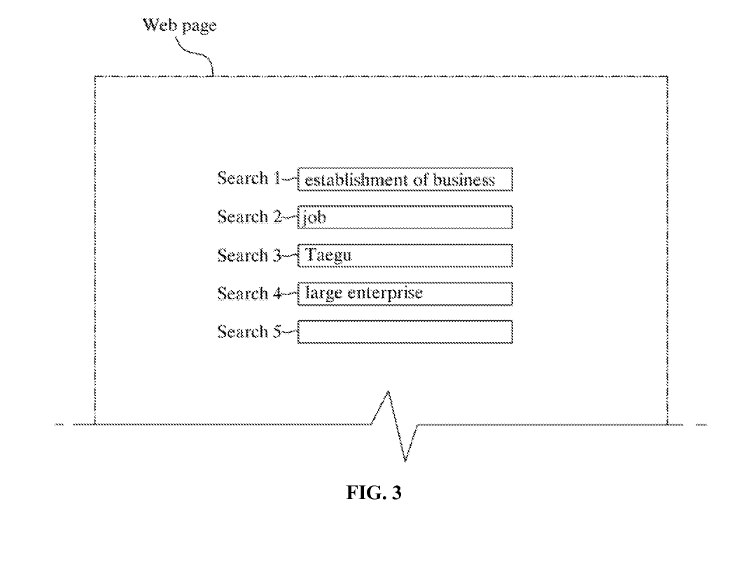

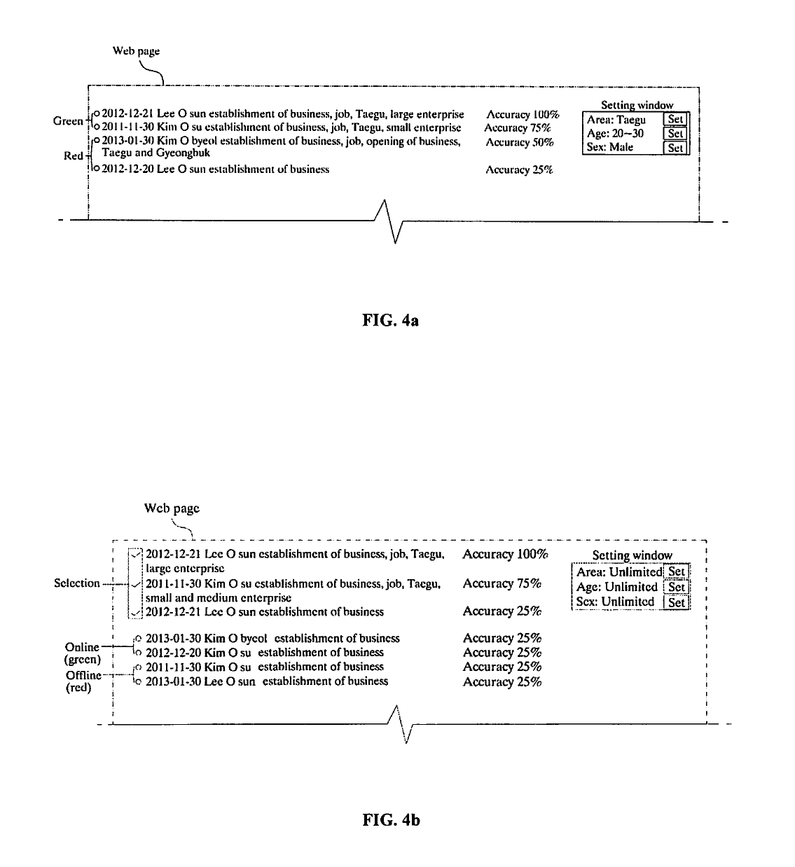

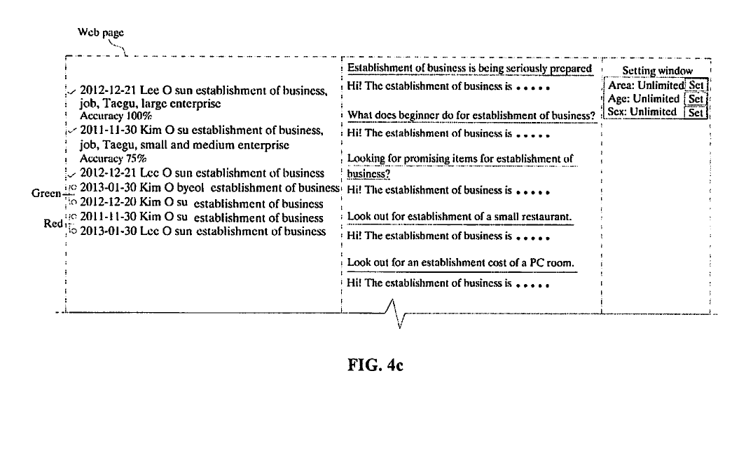

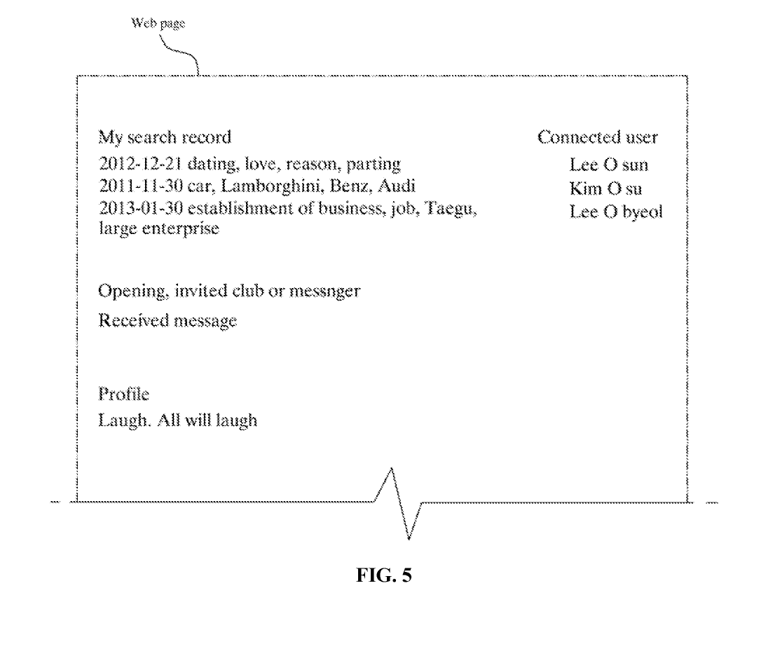

FIG. 2 is a flowchart illustrating a search site user connection method using search words according to the present invention, FIG. 3 is a diagram illustrating an embodiment in which search words are input to a search window of a search site according to the present invention, FIG. 4a is a diagram illustrating an embodiment in which information for a first user is displayed based on a result of determining matched searched words between the first search words and the second search words according to the present invention, FIG. 4b is a diagram illustrating another embodiment in which the information for the first user is displayed based on the result of determining matched searched words between the first search words and the second search words according to the present invention, FIG. 4c is a diagram illustrating yet another embodiment in which the information for the first user is displayed based on the result of determining matched searched words between the first search words and the second search words according to the present invention, and FIG. 5 is a diagram illustrating an embodiment in which second search words, date when the second search words are input, a profile of a second user, and a name of a first user connected to the second user are displayed.

Referring to FIGS. 2 to 5, in the search site user connection method using search words according to the present invention, the database 4 may store at least one first search word input to the search window of the search site by the first user, order in which the first search words are input, and information of the first user together as one piece of search information (S1).

The first user is a user of the search site. When the first user inputs search words to the search window of the search site and performs search, the searched search words may be stored in a database (DB). The search word input to the search window may be input through voice.

Further, the first user may input at least one search word to the search window to perform search, and the first search words including a plurality of search words searched for by the first user may be stored in the database 4, as described above.

When the first search words are stored, a search order of the search site after the plurality of search words of the first search words are input to the search window, and the information for the first user may be stored together in the database 4.

The first search words are a set of search words searched for by being input to the search window of the search site by the first user. For example, when the first user inputs “establishment of business” to the search window to search and further inputs “job” to the search window to perform search, the first search words “establishment of business” and “job.”

Further, the search window to which the first user can input the search word through the search site may be at least one search window. Referring to FIG. 3, the search window of the search site includes five search windows, and search words may be input to the respective search windows. Further, search words may be input to all of the plurality of search windows or search words may be input to some of the plurality of search windows. FIG. 3 illustrates an example which search words are input to four of the five search windows.

While the five search windows of FIG. 3 are arranged in a vertical direction (from top to bottom) on a web page, the five search windows may be arranged in a horizontal direction (from left to right) on the web page, and the arrangement of the respective search windows may be variously changed according to an operation environment of the search site.

The information for the first user may be at least one of a residential area, an age, a sex, a search site ID, a profile, a phone number, a birthday, an address, a hobby, special ability, a motto, a hometown, an academic history, an occupation, a work place, a location of the work place, and interests of the first user. Further, the information for a second user may be the same structure as the information for the first user.

The first user must log in the search site to use the search site and generally inputs the information of the first user to the search site in order to log in the search site, and the input information of the first user may be stored in the database 4.

The residential area of the first user may be identified in units of cities based on the address of the first user or may be identified based on gu, gun, dong or the like which is an administrative district unit smaller than the city.

Then, the second user may input at least one second search word to the search window of the search site (S2). The search words input to the search window may be input through voice.

The second user may input search words for interests to the search window of the search site through the input unit of the terminal 2 to perform search.

The management server 6 may compare the first search words stored in the database 4 with the second search words input to the search window by the second user to determine whether the first search words and the second search words match (S3).

More specifically, the management server 6 may compare the first search words with the second search words to determine whether the first search words and the second search words match and determine the number of the matched search words between the first search words and the second search words. For example, when the first searched words are searched for in order of “establishment of business,” “job” and “Taegu” and the second searched words are searched for in order of “establishment of business,” “small and medium enterprise,” and “job,” the management server 6 may determine that the number of the matched searched words is 2 since the “establishment of business” and the “job” of the first searched words and the “establishment of business” and the “job” of the second searched words match.

In other words, the management server 6 may determine the number of matched searched words by comparing all of at least one search word of the first searched word with all of the at least one search word of the second searched word to find the matched searched words.

Further, the management server 6 may perform a comparison based on order in which the first search words and the second search words have been input to the search window after determining the number of matched search words between the first searched word and the second searched words. A case in which there are a plurality of first users is assumed in order to describe it in greater detail. While a case in which there are a plurality of first users is assumed for convenience of the description, a determination is performed in the same way even when the number of first users is 1.

Since there may be a plurality of first users, the first search words can be a set of a plurality of search words. For example, it is assumed that the first searched words (simply referred to as “search 1”) have been searched in order of “establishment of business,” “job” and “Taegu,” the other first searched words (simply referred to as “search 2”) have been searched in order of “job,” “establishment of business,” and “Taegu,” and the second searched words have been searched as “establishment of business,” “job” and “occupation.”

Since the second search words and search 1, and the second search words and search 2 match in “establishment of business” and “job,” the number of the matched searched words is 2. Since the two searched words “establishment of business” and “establishment of business” and “job” and “job” in search 1 and search 2 each including three searched words match the second search words, accuracy is 66.6%.

The accuracy may be displayed on the display unit together with a result of determining whether the first searched words match the second searched words. Further, the determination results may be displayed from the high-accuracy determination result to the low-accuracy determination result on the display unit of the terminal 2.

Then, since the numbers of matched search words are the same and are 2, the matched searched words are determined based on the order in which the second search words are input and the order in which search 1 and search 2 are input. For the search word matching “establishment of business” first input among the second search words, “establishment of business” in search 1 has first been input and “establishment of business” in search 2 has secondly been input.

Therefore, search 1 including the first input “establishment of business” may be determined to have a higher priority than search 2. In this case, the user who has input search 1 to the search window may first be displayed, as will be described below.

The terminal 2 can be, for example, a computer, a laptop PC, a PDA, a smartphone or the like, but is not limited thereto and any device may be used as long as the device is a device in which a web page can be driven and a search site can be activated.

Further, the determination as to whether the first search words match the second search words may be performed through a combination based on the order in which the first search words and the second search words have been input to the search window in a state in which a residential area, an age or a sex of the first user has satisfied a previously setting range.

Referring to FIGS. 4a and 4b, the second user may adjust a setting range using a setting window which enables the user to adjust the setting range. For example, the setting window includes buttons for setting respective ranges of the residential area, the age and the sex, and the second user may click the setting buttons to adjust the respective setting ranges. The respective setting ranges adjusted by the user may be stored in the database 4.

The setting ranges may be a range of the residential area, a range of the age, and a range of the sex. When the range of the residential area is set, a determination as to whether the first search words of the first user and the search words of the second user within the set range of the residential area match may be made by comparing the first search words with the second search words in the orders in which the first search words and the second search words are input to the search window. For example, when the range of the residential area is set to “Taegu,” the determination as to whether the first search words and the search words match can be made only when the residential area of the first user is “Taegu.”

Further, even when the range of the age or the sex is set, the determination can be made in the same way. Since this is a matter apparent to those skilled in the art, a detailed description is omitted.

Each of the range of the residential area, the range of the age, and range of the sex may be set to a certain range, or the respective setting ranges may be set to a full range to eliminate conditions for the first user and to compare and determine the first search words and the second search words.

The display unit of the terminal 2 may display the information for the first user when one or more of the first search words and the second search words match based on the determination result of the management server 6 (S4).

More specifically, there may be a plurality of first users, and users may be displayed sequentially from users corresponding to the greater number of search words matching between the first search words and the second search words. When the numbers of searched words matching between the first search words and the second search words are the same, the first search words and the second search words may be compared based on the order in which the first search word and the second search word have been input, and the user corresponding to the first input search word may be first displayed.

The information for the first user may be a residential area, an age or a sex of the first user. The residential area of the first user may be identified in units of cities based on the address of the first user or may be identified based on gu, gun, dong or the like which is an administrative district unit smaller than the city.

Referring to FIGS. 4a and 4b, date when the first search words are input to the search window and searched, the first search words, and accuracy indicating a degree of matching between the second search words and the first search words may be displayed. Further, the setting window which enables the user to adjust the setting range may be displayed on the web page together.

The first search words are displayed on the web page in an input order, and the first search words matching the second search words may be displayed in such a manner that the second user can easily confirm the matching. For example, when the first search words and the second search words match each other, color, thickness, size and style of fonts of the first search words matching the second search words may be displayed to be different from those of the first search words not matching the second search words, and a display way may be variously changed.

Further, a step of displaying the information for the first user may further include displaying whether the first user is in an online state or in an offline state. Since it may be displayed whether the first user is in an online state or in an offline state, the second user can select the first user desired to be connected, through the terminal 2. For example, whether the first user is in an online state, a green lamp may be used for display, and whether the first user is in an offline state, a red lamp may be used for display.

Further, Referring to FIG. 4c, when the information for the first user is displayed based on the result of determining the matched searched words between the first search words and the second search words according to the present invention, the information may be displayed together with a window showing the search results for the search words input to the search window by the second user.

For example, a window appearing when search words are searched for using a general search site may be the window showing the search result for the search words input to the search window. While the window showing the search result for the search word is arranged in a center of the web page, the arrangement may be variously changed.

The management server 6 may connect the first user selected by the second user with the second user (S5).

When the second user selects the first user through the terminal 2, the management server 6 may connect the second user with the first user through the network, and the second user may transmit a message, a note or the like to the first connected user or may talk with the first user using a messenger. Further, the second user may invite the first user to a chat room.

The network may be, for example, a wireless network, an Internet network, or a cable network, and is not limited thereto and any other network may be used as long as the network supports communication.

Since the transmission of a message, a note or the like or the invitation of the first user to a talk and chat room using the messenger corresponds to a matter obvious to those skilled in the art, a description thereof is omitted.

Referring to FIG. 5, the second search words searched through input of the second user, date when the second search words are input to the search window, the profile of the second user, and a name of the first user connected to the second user may be displayed through the display unit of the terminal 2. These are matters which may be displayed when the second user selects my page in the search site, and a description of a display method is omitted since the display method is obvious to those skilled in the art.

The profile of the second user may be displayed by displaying his or her motto or status using letters or images.

The second search words may be input to the search window and displayed in a searched order in my search history column or may be displayed together with date when the second search words have been input to the search window.

The way by which my page can be displayed in the search site is not limited to the matter described above, and the second, information related to search of the second user himself or herself and the information for the first user may be displayed in various ways.

While the embodiments according to the present invention have been described above, it will be understood by those skilled in the art that various variations from the embodiments and equivalent embodiments are possible. Therefore, a true technical protection range of the present invention should be determined by the following claims.

### DESCRIPTION OF REFERENCE NUMERALS

2: Terminal 4: Database (DB)

6: Management server

10: Search site user connection system using search words

1. A search site user connection system using search words comprising:
a database which stores at least one first search word input to a search window of a search site by a first user, order in which the first search words have been input, and information of the first user together as one piece of search information;
a terminal which enables a second user to input at least one second search word to the search window of the search site; and
a management server which compares the first search words with the second search words to determine whether the first search words and the second search words match,
wherein the terminal displays information for the first user when one or more of the first search words and the second search words match, and
the management server connects the first user selected by the second user with the second user.

2. The search site user connection system using search words according to claim 1, wherein the information for the first user is at least one of a residential area, an age and a sex of the first user.

3. The search site user connection system using search words according to claim 1, wherein the management server compares the first search words with the second search words to determine whether the first search words and the second search words match, and determines the number of matched search words between the first search words and the second search words.

4. The search site user connection system using search words according to claim 3, wherein the management server compares the first search words with the second search words based on order in which the first search words and the second search words have been input after determining the number of matched search words between the first search words and the second search words.

5. The search site user connection system using search words according to claim 1, wherein:
there are a plurality of first users, and
the terminal
displays the users sequentially from the users corresponding to the greater number of matched search words between the first search words and the second search words, and
compares the first search words with the second search words based on order in which the first search words and the second search words have been input and first displays the user corresponding to the first input search word when the numbers of matched search words between the first search words and the second search words are the same.

6. A search site user connection method using search words comprising:
storing at least one first search word input to a search window of a search site by a first user, order in which the first search words have been input, and information of the first user together as one piece of search information;
inputting, by a second user, at least one second search word to the search window of the search site;
comparing the first search words with the second search words to determine whether the first search words and the second search words match;
displaying information for the first user when one or more of the first search words and the second search words match; and
connecting the first user selected by the second user with the second user.

7. The search site user connection method using search words according to claim 6, wherein the information for the first user is at least one of a residential area, an age and a sex of the first user.

8. The search site user connection method using search words according to claim 6, wherein the comparing of the first search words with the second search words to determine whether the first search words and the second search words match includes comparing the first search words with the second search words to determine whether the first search words and the second search words match and determining the number of matched search words between the first search words and the second search words.

9. The search site user connection method using search words according to claim 8, wherein the comparing of the first search words with the second search words to determine whether the first search words and the second search words match includes comparing the first search words with the second search words based on order in which the first search words and the second search words have been input after determining the number of matched search words between the first search words and the second search words.

10. The search site user connection method using search words according to claim 6, wherein:
there are a plurality of first users, and
the method includes
displaying the users sequentially from the users corresponding to the greater number of matched search words between the first search words and the second search words, and
comparing the first search words with the second search words based on order in which the first search words and the second search words have been input and first displaying the user corresponding to the first input search word when the numbers of matched search words between the first search words and the second search words are the same.
